(19) United States
(12) Patent Application Publication
(10) Pub. No.: US 2016/0176286 A1
(43) Pub. Date: Jun. 23, 2016

(54) TANK SYSTEM WITH A TANK CLOSURE AND VENTILATION

(71) Applicant: GASLOCK GmbH, Iserlohn (DE)

(72) Inventor: Joerg LIENENKAMP, Witten (DE)

(73) Assignee: GASLOCK GmbH, Iserlohn (DE)

(21) Appl. No.: 14/966,192

(22) Filed: Dec. 11, 2015

(30) Foreign Application Priority Data
Dec. 19, 2014 (DE) 20 2014 106 192.4

(51) Int. Cl. B60K 15/04

(52) U.S. Cl. CPC B60K 15/0406; B60K 2015/0451; B60K 2015/049; B60K 2015/03236

(57) ABSTRACT

A tank system for motor vehicles includes a tank closure. The tank closure includes a tank filler neck which forms an access to a fuel tank, and a tank cap which, upon rotating, forms a sealing closure of the tank filler neck. Furthermore, the tank system includes a ventilation channel. A controllable actuating element is movable between an open position and a closed position. In the open position, a connection is opened to the ventilation channel, and the rotation of the tank cap is released. In the closed position, the connection to the ventilation channel is closed, and the rotation of the tank cap is blocked.

### CROSS REFERENCE TO RELATED APPLICATIONS

Applicant claims priority under 35 U.S.C. §119 of German Application No. 20 2014 106 192.4 filed Dec. 19, 2014, the disclosure of which is incorporated by reference.

### BACKGROUND OF THE INVENTION

1. Field of the Invention

The invention relates to a tank system.

2. Description of Related Art

Tank systems for motor vehicles have a tank closure that forms an access via the tank filler neck to the fuel tank and is closed by a tank cap. The tank filler neck is for filling the fuel tank. When the tank closure is in a sealed state, the tank cap arranged on the outside end of the tank filler neck seals the fuel tank gas-tight and pressure-tight to the outside so that, for example while using the motor vehicle, no volatile materials of the fuel can escape.

An overpressure in the fuel tank can form for example at higher temperatures due to the gas-tight and pressure-tight closure of the fuel tank. When there is an overpressure in the fuel tank, fuel vapors can suddenly escape when opening the tank cap which contain potentially harmful volatile substances of the fuel. Fuel can also be entrained, escape to the outside, and soil operating personnel or the environment.

A tank system is described in GB 2 286 182 A which has a ventilation channel for decreasing the overpressure that, for example, forms a passage between the fuel tank and an active charcoal filter. The active charcoal filter serves to absorb the volatile substances of the fuel and can bring about an at least partial fuel pressure decrease. The ventilation channel can be arranged proceeding from the tank filler neck to guide the fuel vapors away from this critical point to the active charcoal filter. The opening of the ventilation channel can be controlled by a pressure relief valve so that, when there is overpressure in the fuel tank, a path from the tank filler neck to the ventilation channel is accessible. However, the tank closure is nonetheless able to be opened when there is overpressure.

A tank closure which addresses this problem is disclosed in DE 199 56 350 A1. With the tank closure described therein, an actuating drive is coupled to a tank flap and the pressure relief valve to prevent an opening of the tank closure when there is overpressure.

### BRIEF SUMMARY OF THE INVENTION

It may be considered an object to design a tank system such that a decrease in pressure can occur when opening the tank closure and thereby reliably prevent a release of fuel vapors and fuel.

The tank system according to the invention comprises a tank closure with a tank filler neck and a tank cap that forms a sealing closure of the tank filler neck upon rotating. Furthermore, the tank system comprises a ventilation channel and a controllable actuating element. The tank filler neck of the tank system serves as an opening to the fuel tank. When the tank closure is open, the fuel tank can be filled with fuel through this opening. The actuating element is movable between an open position and a closed position, wherein in the open position, a connection is opened to the ventilation channel, and the tank cap is unlocked to allow rotation, whereas in the closed position, the connection to the ventilation channel is closed, and the rotation of the tank cap is blocked.

When the controllable actuating element is in the open position, an overpressure in the fuel tank can thereby be decreased in that pressure equalization occurs via the ventilation channel and, for example, fuel vapors that for example consist of volatile fuel components, can escape along this path. This can prevent the release of fuel and fuel vapors when opening the tank cap and reduce endangerment of humans and the environment. A delay between the opening of the ventilation channel and the opening of the tank closure may result during the time that the user requires between enabling the actuating element and rotating the tank closure. Unintentional opening of the tank closure can be prevented in that the actuating element blocks the rotation of the tank cap in closed position.

The tank system is preferably the tank system of a motor vehicle, particularly preferably a two, three or four-wheel motor vehicle such as a motorcycle, motor scooter, trike or quad. In particularly preferred embodiments, the tank system is part of the fuel system of a motorcycle.

The tank closure is particularly preferably designed as a threaded lock; however, a design as a bayonet lock can also be advantageous. When the tank closure is designed as a threaded lock, the tank filler neck preferably has an inner thread, and the tank cap has a matching outer thread.

To form a tight closure of the tank closure, the tank cap preferably has a seal. Particularly preferably, the seal is arranged just above the thread so that by rotating, a sealing closure of the fuel tank with the upper edge of the tank filler neck can be formed. It is advantageous if the seal consists of a material impermeable and insensitive to the components of the fuel.

The ventilation channel preferably leads to a container which contains an active charcoal filter. The active charcoal filter can bind the volatile components of a fuel contained in the fuel vapors. Fuel components potentially harmful to health can thereby be captured, the pressure in the tank can be at least partially reduced, and possible hazards to individuals can hence be decreased.

The tank system provides a reliable closure of the fuel tank and simultaneously serves to release pressure before opening the closure. Both functions are effected by the actuating element. The use of a common element for reducing pressure and locking and unlocking the tank closure simplifies the design and operation of the tank system. In closed position, the tank closure is securely locked, whereas in open position, easy and reliable access to the fuel tank is possible due to the automatic pressure release.

Preferably, the tank system has a sensor for the position of the actuating element. It is particularly advantageous when the sensor provides a signal for a control unit which communicates with the ignition of an engine. It is furthermore advantageous when the ignition and the actuating element are operated by an ignition selector switch. This can prevent an opening of the fuel tank while the engine is miming as well as opening by unauthorized persons without an ignition key. Furthermore, it can prevent the motor vehicle from being started when the tank is open.

In one preferred embodiment of the tank system, the actuating element is recessed into the wall of the tank filler neck and is radially adjustable relative to the tank closure. Preferably, the actuating element is also an access point to the ventilation channel. In one advantageous embodiment of the tank system, the actuating element possesses a latch that is movable along a direction of movement radial to the tank closure. It is particularly advantageous when the tank cap has an opening in which the bolt of the actuating element can be accommodated in a form-fit manner. The rotation of the tank cap can be thereby released or blocked, or the connection to the ventilation channel can be thereby opened or closed. This increases the reliability of the tank closure.

In one particularly advantageous embodiment of the tank system, the sensor can determine whether or not the bolt is located in the opening in the tank cap. For example, if the tank cap has not been rotated properly into the tank filler neck, e.g. after filling the fuel tank, the bolt may not be located in the opening of the tank cap. If for example the ignition of the engine is enabled by the ignition selector switch, a signal can be sent to the control unit. The control unit then attempts to switch the actuating element into the closed position. If the tank cap is not sealingly rotated into the tank filler neck, the bolt cannot, however, move into the provided opening. The sensor detects this incorrect position of the actuating element and supplies a corresponding signal for the control unit. The control unit then prevents an ignition of the engine. The engine ignition only occurs if the tank cap has been rotated into the correct position in which the bolt can be accommodated in the opening. This can prevent ignition when the actuating element is in the wrong position, for example when the tank closure is not completely closed, and increases operating safety.

In one advantageous embodiment, the actuating element is adjustable, for example by a spindle drive, a spring mechanism, or an electromechanical element. The use of a lifting magnet or another electromechanical element such as an electric motor or a piezo drive is particularly advantageous as a drive for the actuating element. This allows the actuating element to precisely and reliably change its position. Particularly preferably, a common actuating element for both functions, locking and ventilation, is accordingly provided. More preferably, the adjustment to fulfill both functions can be effected by a uniform movement, in particular a linear movement. Accordingly, intermediate gears or the like can be dispensed with.

In particularly advantageous embodiments of the tank system, the actuating element has a movable part that, in open position, opens a connection to the ventilation channel and releases the rotation of the tank cap and, in closed position, closes the connection to the ventilation channel and blocks the rotation of the tank cap. This can simplify the design of the actuating element. In order for example to increase the safety of the use of the tank closure, the movable part can be designed so that a certain delay occurs between the ventilation of the fuel tank and the release of the tank cap. Accordingly before opening the tank closure, a decrease in pressure can for example occur in the fuel tank, or volatile substances of the fuel can be bound in the active charcoal filter respectively.

In one alternative embodiment, the actuating element can comprise a valve element and a bolt element, wherein the valve element opens or closes the connection to the ventilation channel and the bolt element releases or blocks the rotation of the tank cap, wherein the valve element and the bolt element are coupled to each other for a common movement. In certain circumstances, the individual elements can hence be better adapted to their function. In one preferred embodiment, this design of the actuating element can also be used so that a certain delay occurs between the ventilation of the fuel tank and the release of tank cap. The fuel tank can hence already be ventilated in this embodiment as well while the tank cap still cannot be rotated.

### BRIEF DESCRIPTION OF THE SEVERAL VIEWS OF THE DRAWINGS

In the following, an embodiment of the invention will be further described with reference to the drawings. In the drawings:

FIG. 1 shows a schematic representation of a cross-section of a tank system, wherein an actuating element is located in a closed position;

FIG. 2 shows a schematic representation of a communication between a sensor of a tank system, a control unit and an ignition selector switch;

FIG. 3 shows an overview drawing of a tank system with a tank closure and actuating element in a cross-section, wherein the actuating element is located in closed position, and a fuel tank and an active charcoal filter are shown;

FIG. 4 shows a schematic representation of a cross-section of a tank system, wherein the actuating element is located in open position;

FIG. 5 shows a schematic representation of a cross-section of a tank system, wherein an actuating element is located in closed position and a tank cap is open.

### DETAILED DESCRIPTION OF EMBODIMENTS

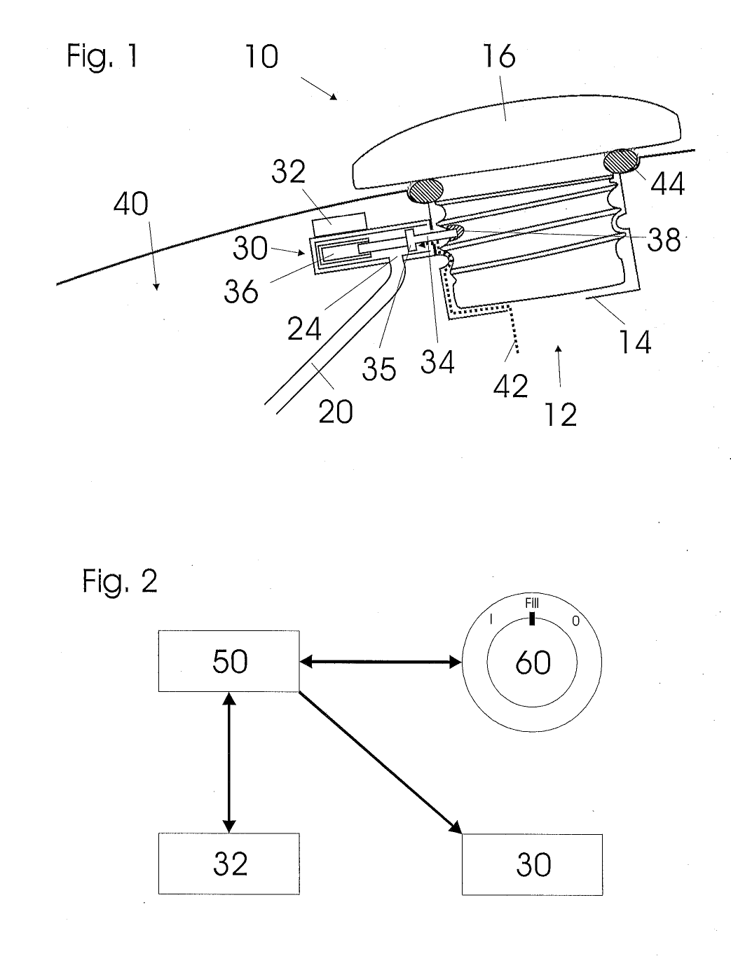

FIG. 1 schematically portrays the cross-section of a tank system 10 with a tank closure 12 and actuating element 30.

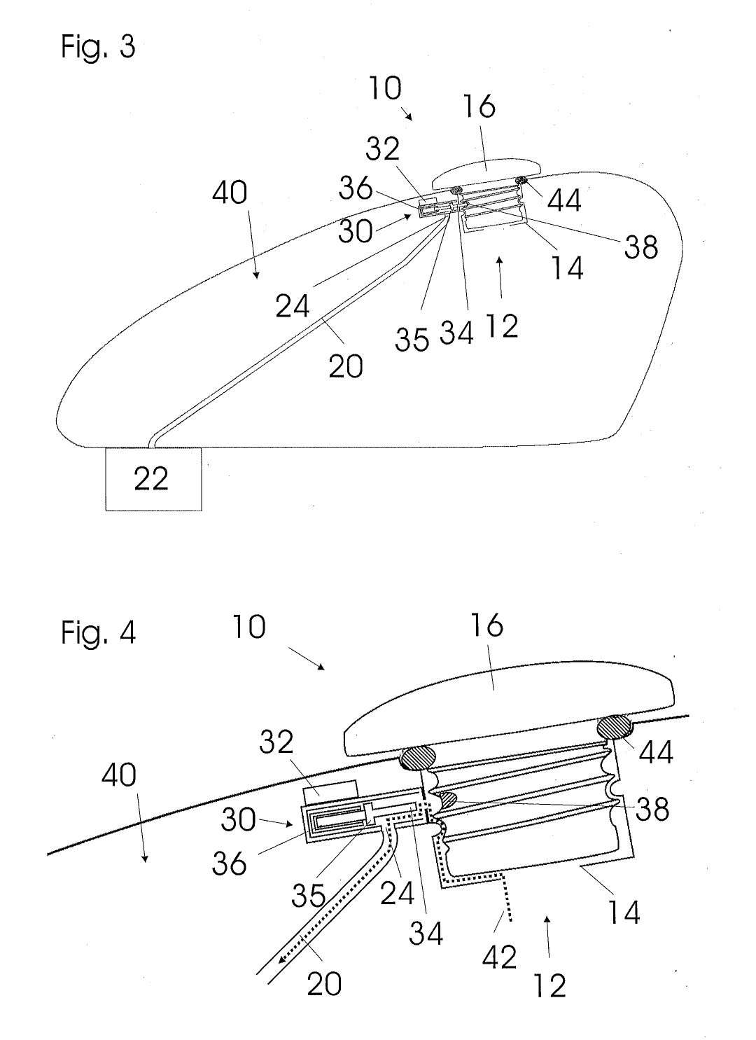

The tank system 10 contains a tank closure 12 that comprises a tank filler neck 14 and a tank cap 16. The tank filler neck 14 forms an access to a fuel tank 40 (see also FIG. 3) through which the fuel tank can be filled. In the portrayed embodiment, the tank filler neck 14 possesses an inner thread in which the tank cap 16 fits and is screwed with its outer thread. By rotating the tank cap 16, a sealing closure of the tank filler neck 14 can therefore be formed by rotating the tank cap 16 far enough into the tank filler neck 14 so that a seal 44 of the tank cap 16 is pressed sufficiently for the sealing closure against the top side of the tank filler neck 14.

An actuating element 30 is recessed into the wall of the tank filler neck 14. The actuating element 30 can be moved by a lifting magnet 36 into different positions. This actuating element 30 is situated radial to the tank cap 16. The tank cap 16 has an opening 38 in which a bolt 34 of the actuating element 30 can be accommodated in a form-fit manner.

The opening 38 is only accessible to the bolt 34 when the tank cap 16 is located in a certain position within the tank filler neck 14. This position is distinguished in that the tank cap 16 is screwed into the tank filler neck 14 so that a sealing closure of the fuel tank 40 exists. This position can for example be confirmed by a stopping of the tank cap 16.

FIG. 1 shows the actuating element 30 in a closed position in which the bolt 34 is located in the opening 38. Rotation of the tank cap 16 is blocked by the closed position, and the tank closure 12 cannot be opened. Furthermore, a connection 24 to a ventilation channel 20 is closed by the actuating element 30, and no fuel vapors 42 from the fuel tank 40 can pass through the tank filler neck 14 to the ventilation channel 20. Consequently when in closed position, the actuating element 30 closes the connection to the ventilation channel 20 and prevents an opening of the tank closure 12.

FIG. 2 depicts the communication between a sensor 32 of a tank system, a control unit 50 and an ignition selector switch 60 which can effectuate an ignition of an engine. The position of the actuating element 30 is detected by the sensor 32. In the depicted embodiment, this provides a signal for a control unit 50 that communicates with the ignition selector switch 60 and the ignition of the motor. Depending on the position of the actuating element 30, the signal of the sensor 32 therefore prevents or enables the ignition of the engine. Since the actuating element 30 is in closed position in FIG. 1, the sensor 32 supplies a corresponding signal to the control unit 50 which enables the ignition of the engine.

A connection exists extending from the actuating element 30 to the ventilation channel 20 which, in this embodiment, leads to a container with an active charcoal filter 22. This is shown in the overview (FIG. 2) in which the tank system 10 is depicted with the ventilation channel 20, the tank closure 12, the actuating element 30, the active charcoal filter 22 and the fuel tank 40. The ventilation channel 20 constitutes a passage between the active charcoal filter 22 and the fuel tank 40. The accessibility of this passage is determined by the position of the actuating element 30 since a flange 35 of the bolt 34 can close or open the connection between the ventilation channel 20 and the tank filler neck 14. In the closed position shown in FIG. 1, this connection is closed.

While a motor vehicle, such as a motorcycle, containing the described tank system 10 is travelling, the actuating element 30 is in closed position. The bolt 34 is shoved into the opening 38 of the tank cap 16, and the connection 24 to the ventilation channel 20 is closed by the flange 35 of the bolt 34. To fill the fuel tank 40 of the motorcycle, first the ignition selector switch 60 is actuated and the engine is turned off. The ignition selector switch 60 can now be switched by an operator to a fuelling position. During this process, the ignition selector switch 60 sends a signal to the control unit 50. The control unit processes this signal and sends a signal to the actuating element 30 to move it into an open position (see FIG. 4).

FIG. 4 shows the actuating element 30 in the open position. The bolt 34 is moved out of the opening 38 and releases the rotation of the tank cap 16. Due to the movement of the bolt 34, the connection 24 to the ventilation channel 20 is no longer closed by the flange 35. By means of this release of the connection 24 to the ventilation channel 20, fuel vapors 42 from the fuel tank 40 can reach the active charcoal filter 22. Volatile substances from the fuel vapors can be bound in the active charcoal filter 22. As a result, an at least partial decrease in pressure in the fuel tank 40 can occur. A certain delay between ventilating the fuel tank 40 and opening the tank closure 12 is for example established by the time required by the operator to rotate the tank cap 16 out of the tank filler neck 14. The actuating element 30, in particular the bolt 34, can also be designed so that the flange 35 releases the connection 24 while the tip of the bolt is still located for a short time in the opening 38 of the tank cap.

When the tank cap 16 is rotated out of the tank filler neck 14, the fuel tank 40 can be filled with fuel through this opening.

After the fuelling process is concluded, the tank cap 16 is screwed back into the tank filler neck 14 in order to close the tank closure 12. If the tank cap 16 is screwed into the tank filler neck 16 so that a pressure-tight closure of the tank closure is formed, the bolt 34 can be moved into the opening 38 by a corresponding signal of the control unit 15, for example when starting the engine or turning off the motorcycle. The flange 35 of the bolt 34 thereby closes the connection 24 to the ventilation channel 20. The actuating element 30 is then again in closed position (see FIG. 1).

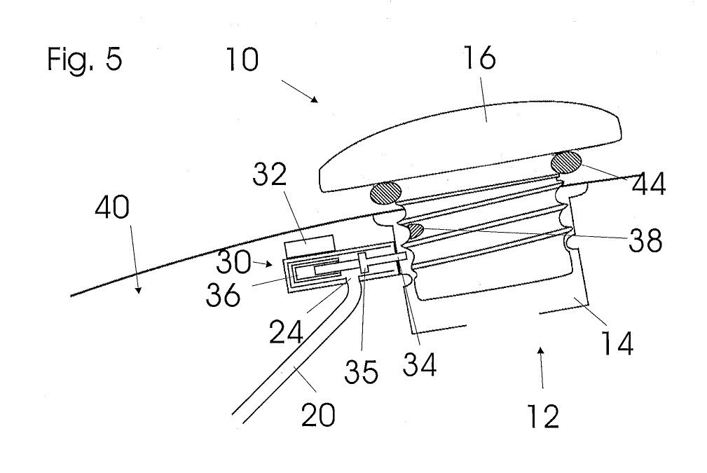

If the tank cap 16 is not properly screwed into the tank filler neck 16 after fuelling, a pressure-tight closure of the tank closure 12 cannot be formed (see FIG. 5). If the operator activates the ignition selector switch 60 or the engine ignition, said ignition selector switch 60 sends a signal to the control unit 50 (see FIG. 2). Said control unit 50 then provides the actuating element 30 with the command to move into the closed position. Since the tank cap 16 is however located in the wrong position, the bolt 34 cannot be moved into the opening 38 in the tank cap. The sensor 32 detects this changed position of the actuating element 30 and supplies a signal for the control unit. Since this position does not correspond to the closed position or the open position, the control unit 50 can prevent an engine ignition. The engine ignition can only occur when the tank cap 16 has been rotated into the correct position in which the bolt 36 can be accommodated in the opening 38. Furthermore, the control unit can send a signal, e.g. acoustically and/or visually, to the operator to notify the operator to correctly close the tank cap 16.

In another embodiment (not shown), the actuating element 30 consists of a valve element and a bolt element which are coupled to each other. The valve element opens or closes the connection to the ventilation channel 20, and the valve element releases the rotation of the tank cap 16 or blocks it. This design of the actuating element 30 can be employed so that there is a certain delay between the ventilation of the fuel tank 40 and the release of the tank cap 16 since, for example, the valve element can be operated at a time before the bolt element. The fuel tank 40 can hence already be ventilated while the tank cap still cannot be rotated.

What is claimed is:

1. A tank system comprising
a tank closure comprising a tank filler neck which forms an access to a fuel tank, and a tank cap which, upon rotating, forms a sealing closure of the tank filler neck,
a ventilation channel,
a controllable actuating element which is movable between an open position and a closed position, wherein in the open position, a connection is opened to the ventilation channel, and the rotation of the tank cap is released, whereas in the closed position, the connection to the ventilation channel is closed, and the rotation of the tank cap is blocked.

2. The tank system according to claim 1, comprising
a sensor for determining the position of the actuating element.

3. The tank system according to claim 2, wherein
the sensor supplies a signal for a control unit which communicates with the ignition of an engine.

4. The tank system according to claim 3, wherein
the signal of the sensor either prevents or enables the ignition of the engine depending on the position of the actuating element.

5. The tank system according to claim 1, wherein
the actuating element is recessed in the wall of the tank filler neck and is radially adjustable relative to the tank closure.

6. The tank system according to claim 1, wherein
the actuating element possesses a bolt which is movable along a direction of movement radial to the tank closure.

7. The tank system according to claim 6, wherein
the tank cap has an opening in which the bolt of the actuating element can be accommodated in a form-fit manner.

8. The tank system according to claim 1, wherein
the actuating element has a movable part which, in the open position, opens a connection to the ventilation channel and releases the rotation of the tank cap, and in the closed position, closes the connection to the ventilation channel and blocks the rotation of the tank cap.

9. The tank system according to claim 1, wherein
the actuating element comprises a valve element and a bolt element, wherein the valve element opens or closes the connection to the ventilation channel, and the bolt element releases or blocks the rotation of the tank cap, wherein the valve element and the bolt element are coupled to each other for a common movement.

10. The tank system according to claim 1, wherein
the ventilation channel leads to an active charcoal filter for absorbing volatile components of a fuel from the fuel tank.
